(19) United States
(12) Patent Application Publication
(10) Pub. No.: US 2009/0067822 A1
(43) Pub. Date: Mar. 12, 2009

(54) Method and apparatus for searching recordable discs in a disc library for available recording space

(76) Inventors: Carolynn Rae Johnson, Allison Park, PA (US); Barron Steven Anthony, Carmel, IN (US)

Correspondence Address: Robert D. Shedd;Thomson Licensing LLC, PO Box 5312, PRINCETON, NJ, 08543-5312, US

(21) Appl. No.: 11/920,193

(22) PCT Filed: Mar. 3, 2006
(86) PCT No.: PCT/US2006/007644

§ 371 Date: Nov. 9, 2007

Related U.S. Application Data
(60) Provisional application No. 60/679,325, filed on May 10, 2005.

(51) Int. Cl. H04N 5/00

(52) U.S. Cl. 386/126; 386/E05.064

(57) ABSTRACT

An audio/video recording apparatus stores and provides information regarding audio/video recording medium, such as recordable discs, recorded by the audio/video recording apparatus including disc number, disc name, title of audio/video content stored on the disc, and empty contiguous spaces available on the disc for additional recording. The present apparatus allows a user to look up and view such information about a disc even when the disc is not currently inserted or available by the apparatus. On-screen searching of all disc information stored to the disc library for a specified amount of space available for recording given a desired recording quality, is also provided. The present invention eliminates the need for a user to review blocks of contiguous, available space on a disc-by-disc basis to determine whether there is enough space to fit a desired recording.

### TECHNICAL FIELD

The present invention pertains to audio/video recording devices and, more particularly, to storage of information about recordable media that has been used to record audio/video information via an audio/video recording device.

### BACKGROUND ART

Audio/Video (A/V) recording devices have been known for some time. Until recently video cassette recorders known as VCRs were the predominate means for recording A/V content. VCRs use cassette tapes for recording A/V content. A/V content may be recorded on and erased from any portion of the tape. A user may choose to record A/V content starting at any point on the tape or erase a given portion of A/V content from the tape. As such, some portions of the tape may contain A/V content while other portions of the tape may contain blank areas. Since tapes can only record and play back A/V content in a continuous manner, it is difficult to locate blank areas for recording. Moreover, it is then difficult to determine the amount of recording time available for the blank area.

In view of the above, some VCRs build and maintain a tape library whereby a user can look up information about a VCR tape that has been used to record content via the VCR, including the spaces available on that tape for recording additional content. An exemplary illustration of an on-screen display of a tape library is depicted in FIG. 1.

Particularly, FIG. 1 depicts an on screen display 10 of a tape library of a VCR. The tape library provides a tape list that is a listing of the contents of a particular VCR tape. The tape list indicates the name of the selected VCR tape and a listing of its contents. Particularly, the tape list provides a listing of the A/V content recorded on the selected VCR tape by title and its running time. Additionally, the tape list identifies blank areas of the selected VCR tape and an associated length of available recording time. The tape list provides the listing in running order.

As can be deduced from the on screen display 10, there are several problems associated with this method of looking for available recording space. One problem is that the empty spaces for each tape are listed as individual titles within the information for a particular tape. Another problem is that there is no means to search for this information across multiple tapes. The user must therefore search on a tape-by-tape basis in order to find a desired length of available recording space.

Moreover, such previous recording devices do not allow the user to indicate that he wants to make the new recording at something other than a default recording quality, which would change the estimates of time that can be recorded. For example, in FIG. 1, the tape list indicates two blank spaces or portions of tape that are available for recording, one for thirteen (13) minutes and one for seventy-eight (78) minutes. However, if the user wishes to record at HQ quality level and these times are listed for SP quality level, then such time estimates will be incorrect, leading to potential loss of desired content.

Additionally, alternative devices for recording audio/video programming are now become readily available, including hard disk based personal video recorders (PVRs), DVD recorders, and combination units that includes the ability to record on two or more recordable media.

It can therefore be appreciated from the above that there is a need for improved apparatus and method to search for available recording space in a library comprising recordable media.

### SUMMARY OF THE INVENTION

An A/V recording device stores and provides information regarding audio/video recording discs recorded by the audio/video recording apparatus including disc number, disc name, title of audio/video content stored on the disc, and empty contiguous spaces available on the disc for additional recording, including space based on a specified level of recording quality. This information is retrievable and viewable even when the disc is not currently inserted into the device.

The present A/V recording device also provides on-screen searching of all disc information stored in the disc library for a specified amount of space available for recording given a desired recording quality. Other features are provided including the ability to sort discs by available recording space.

In one form, there is provided an audio/video recording device having memory, a controller coupled to the memory, data entry means and an on screen generator coupled to the controller. The memory stores a listing of removable storage media and respective recordable space data associated with each of the removable storage media. The controller causes the respective recordable space data to be stored in, and read out from the memory. The data entry means receives user input including search commands related to the removable storage media. The on screen generator generates a listing of removable storage media having a sufficient amount of contiguous recording space available for a desired recording length entered by a user.

In another form, there is provided a method of operation of an A/V recording device. The method includes the steps of (a) storing a listing of removable storage media and respective recordable space data associated with each of the removable storage media, (b) receiving user input regarding a desired recording length, and (c) generating, in response to the user input, a listing of removable storage media having a sufficient amount of contiguous recording space available for the entered desired recording length.

The present invention eliminates the need to manually search through the listing for each and every disc to determine whether there is enough contiguous space left on a particular disc to record an additional program, and at a particular desired recording quality level.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a representation of a prior art screen display of a prior art tape library;

FIG. 2 is a block diagram of an exemplary A/V recording device operable according to the principles of the present invention, the A/V recording device shown connected to a display;

FIG. 3 is a representation of an exemplary screen display showing disc library information in accordance with the principles of the present invention;

FIG. 4 is a representation of another exemplary screen display showing disc library information in accordance with the principles of the present invention;

FIG. 5 is a representation of an exemplary screen display in response to selection of searching for recording space from the screen display of FIG. 4;

FIG. 6 is a representation of an exemplary screen display in response to user input of information of recording time and quality from the screen display of FIG. 5; and

FIG. 7 is a flowchart of an exemplary manner of operation of the exemplary A/V recording device of FIG. 2 in accordance with the present principles.

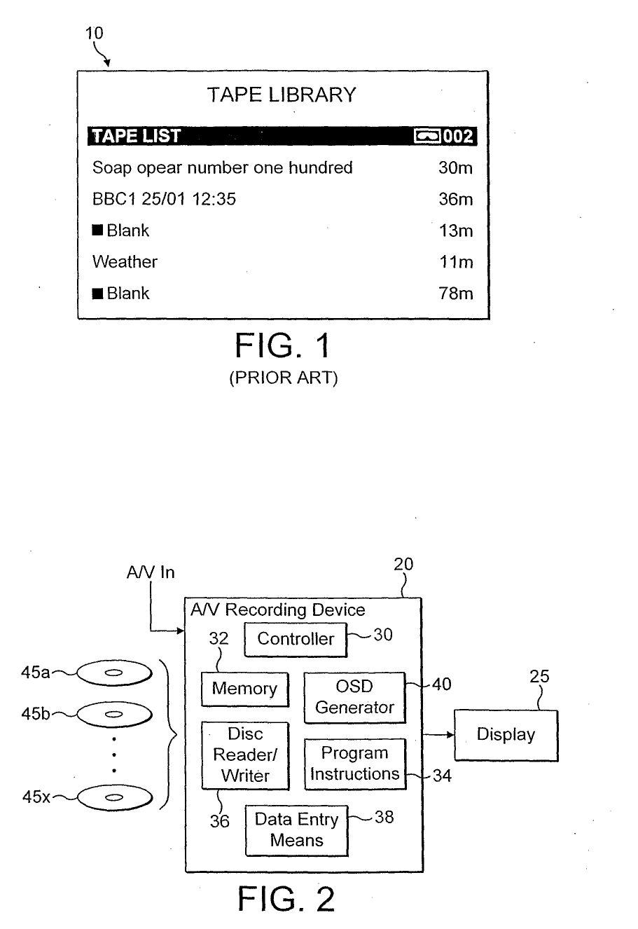

Corresponding reference characters indicate corresponding parts throughout the several views.

### DETAILED DESCRIPTION OF THE PREFERRED EMBODIMENT

FIG. 2 depicts a block diagram of an audio/video (A/V) recording apparatus or device, generally designated 20, that is operable in the manner described herein. It should be appreciated that while not described in detail herein, the device 20 is operable to record, play and/or process A/V content or programming in a manner that is known in the art.

The A/V recording device (hereinafter, device) 20 includes a controller 30 that is configured, operable and/or adapted to provide control of the various components, modules or sections of the device in the manner described herein as well as those functions associated with such an A/V recording device and not specifically described herein, and processing of the A/V content. Memory 32 is provided that is in communication with the controller 30. The memory 32 stores data and provides the stored data as necessary to the various components as appropriate and under the control of the controller 30. Particularly, the controller 30 controls the reading and writing of information to and from the memory 32 as well as the dissemination of that data to the appropriate components per the present principles.

The device 20 also includes a disc reader/writer 36 that is adapted, configured and/or operable to accept one or more recordable discs as represented by recordable discs 45a, 45b through 45x. The recordable discs and thus the disc reader/writer 36 may be optical discs such as CDs and/or DVDs. The device 20 may utilize other types of recordable discs or recordable media. The reader/writer 36 is thus operable, configured and/or adapted to receive A/V content and write the A/V content onto a recordable disc in a manner such as is known in the art. As well, the reader/writer 36 is operable, configured and/or adapted to read A/V content from a disc onto which the A/V content has been written such as is known in the art and provide the A/V content to the display 25 or otherwise as appropriate.

Program instructions 34 are included that provide the necessary programming to allow the device 20 to operate properly including in accordance with the present principles. The program instructions 34 may be stored in RAM, ROM or other memory or storage device. The program instructions 34 are utilized by the controller 30 to perform the necessary functions.

Data entry means 38 is also provided for allowing a user to input commands, menu selections and/or data as is appropriate. The data entry means 38 may comprise a remote control, such as in infrared (IR) remote control, and a remote control receiver, such as an IR receiver. The data entry means 38 may comprise or include, in addition to a remote control system, a keypad or other manner of allowing a user to input commands and/or data.

The device 20 further includes an on-screen display (OSD) generator 40. The OSD generator 40 is operable, configured and/or adapted to provide signals for the on-screen display of menus, text, data and/or the like. The device 20 is shown connected to a display 25 for receipt and display of such on-screen generated menus, text and/or data as well as for viewing A/V content recorded on an inserted or available disc. The display 25 may or may not be incorporated into the device (or vice versa) and include one of a plurality of display devices, including, CRT, LCD, plasma, LCOS, and DLP display devices.

The device 20 accepts audio and video (A/V) input signals (A/V IN) for processing and recording onto a disc via the disc reader/writer 36. A/V signals are outputted to the display 25 as represented by the arrow from the device 20 and the display 25. The A/V signals (e.g. television signals) provide or are A/V content or programming that may be recorded by the device 20.

In accordance with the principles of the present invention, the memory 32 creates, stores and maintains a disc library. The disc library stores and maintains (updates as necessary) information and/or data about each disc onto which A/V content has been recorded by the device 20 or will be used (i.e. a new or blank disc inserted into the device) by the device 20 to record A/V content. Particularly, the disc library contains a list or listing of all recordable discs onto which A/V content has been recorded by the device 20 (or will be in the case of a new disc inserted into the device) as well as data regarding the disc itself, data associated with the A/V content recorded on the disc, and data regarding blank areas or spaces remaining on the disc. As such, a user can look up information regarding discs that are not inserted into the device 20.

The disc library stores data for each and every disc such as disc number (or other unique identifier), disc name, title of A/V content recorded on the disc, running time of the A/V content on the disc, order of A/V content, quality of recorded A/V content, and recording space remaining on a disc. The disc library particularly contains data regarding contiguous recording space remaining on a disc.

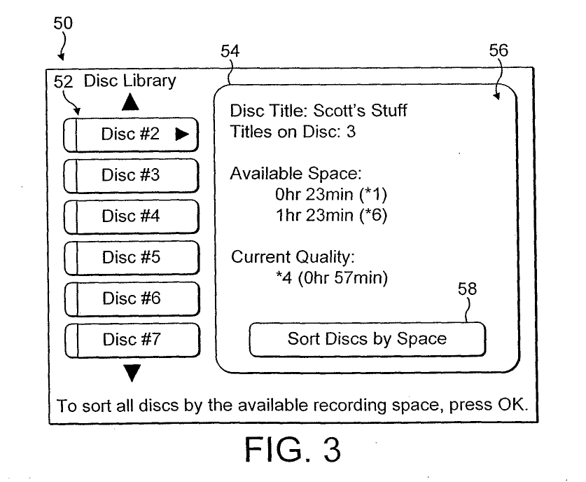

FIG. 3 depicts an exemplary screen display 50 of a disc library in accordance with the present principles. It should be appreciated that this screen display, as well as all other screen displays, are provided by the OSD generator that generate a display signal, which can be displayed on an appropriate display device). The disc library contains a list or listing 52 of discs onto which A/V content has been recorded here identified by disc number (i.e. “Disc #”). The up and down arrows at the top and bottom of the list indicate that the user can scroll up or down the list and possibly view more discs in the disc library.

In this example, the user has selected Disc #2 for review as indicated by the arrow within the Disc #2 box. An information box 54 is provided in response to such user selection. The information box 54 provides the data 56 stored in the disc library regarding the selected disc. The disc data 56 includes the disc title (i.e. “Scott's Stuff”), the number of title on the disc (i.e. “3”), the available (remaining) space on the disc for recording additional content (i.e. two contiguous amount of empty space, one for 0 hours, 33 minutes, and another for 1 hour, 23 minutes) and the quality (by number). Also provided is the currently selected recording quality (“4”) and the amount of available recording space given that level of recording quality.

The information box 54 also provides a selection 58 for the user to sort all of the discs (disc data in the disc library) by available recording space (i.e. “Sort Discs by Space”). This will order the discs in either ascending or descending order as requested by the user. The device 20 provides a sorted list of discs in the disc library and the amount of contiguous space remaining on each of the discs. The list can be sorted by disc information, for example the disc number or alphabetical listing of the disc titles. Alternatively, the discs (disc data of the disc library or the disc library for short) can be sorted by the amount of recordable time left on the disc.

In that regard, the recordable time left on the disc may be all of the recordable time on the disc—including an aggregate of the all of the contiguous and non-contiguous times (recordable space) left on the disc, or alternatively, the recordable time of the largest amount of contiguous time on the disc. The user may specify that the sorted list include all of the discs in the disc library or only a portion of the discs in the disc library, for example only discs numbered 1-20. In this manner, the user is able to get a quick overview of the recordable times remaining for a number of discs rather than searching for specific discs.

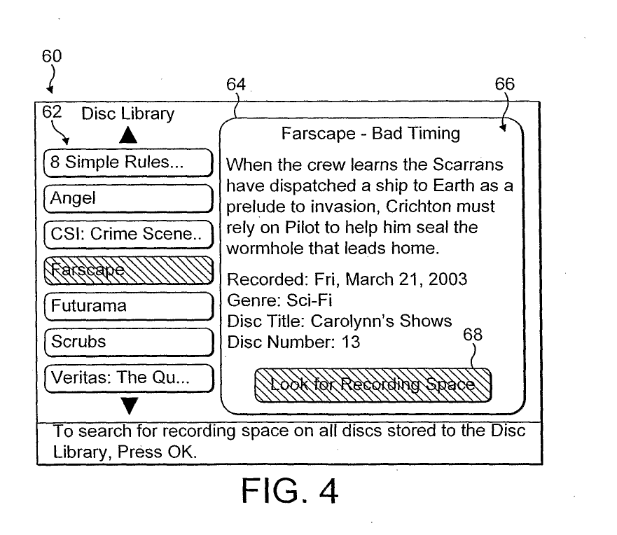

The A/V recording device also allows the user to initiate various modes of searching of the disc library such as by the various data fields stored in the disc library. Referring to FIG. 4, there is illustrated another exemplary screen display 60 depicting title information (A/V content title information) 62 for a selected disc in the disc library. The title information 62 lists various television programming/content that has been recorded on a selected disc.

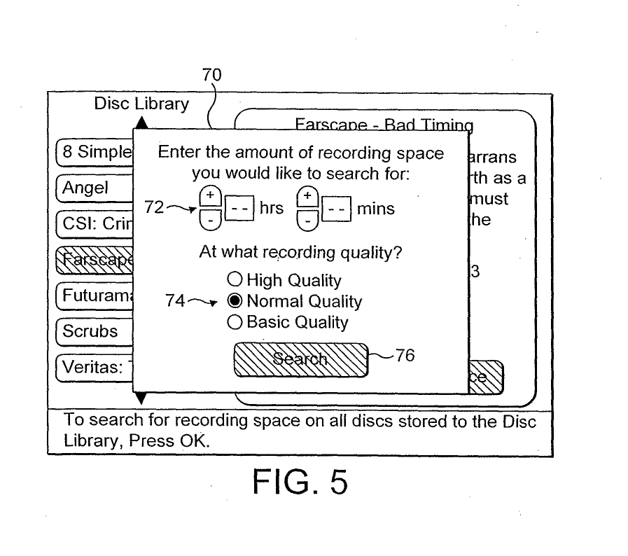

The user has selected the program “Farscape” which brings up an information box 64 for the programming “Farscape”. In particular, individual programming data 66 is provided for this title. The information box 64 provides a control element “Look for Recording Space” 68 that allows the user to select same for searching or looking for recording space. Other implementations might include a menu button to initiate this search from a menu or a remote control button that directly accesses the search screen. Once the user has selected “Look for Recording Space” 68, another screen display, such as the screen display 70 of FIG. 5, is provided. This screen or information box 70 allows the user to enter an amount of time in hours and minutes that correspond to the time the user desires to record. For example, this might be the length of a particular program.

Particularly, the information box 70 provides a recording space input area 72 that allows the user to input an amount of time in hours and minutes that the user would like to determine if a disc has that amount of recordable time remaining thereon. Moreover, the screen 70 allows the user to select the desired recording quality level available. A recording quality input area 74 is provided that allows the user to select from the available recording qualities, here a Basic Quality, a Normal Quality and a High Quality. The user has selected the Normal Quality as represented by the dot adjacent the Normal Quality designation. Once the user has entered and/or selected the amount of time and the recording quality, the Search button 76 is selected to conduct a search according to the entered parameters.

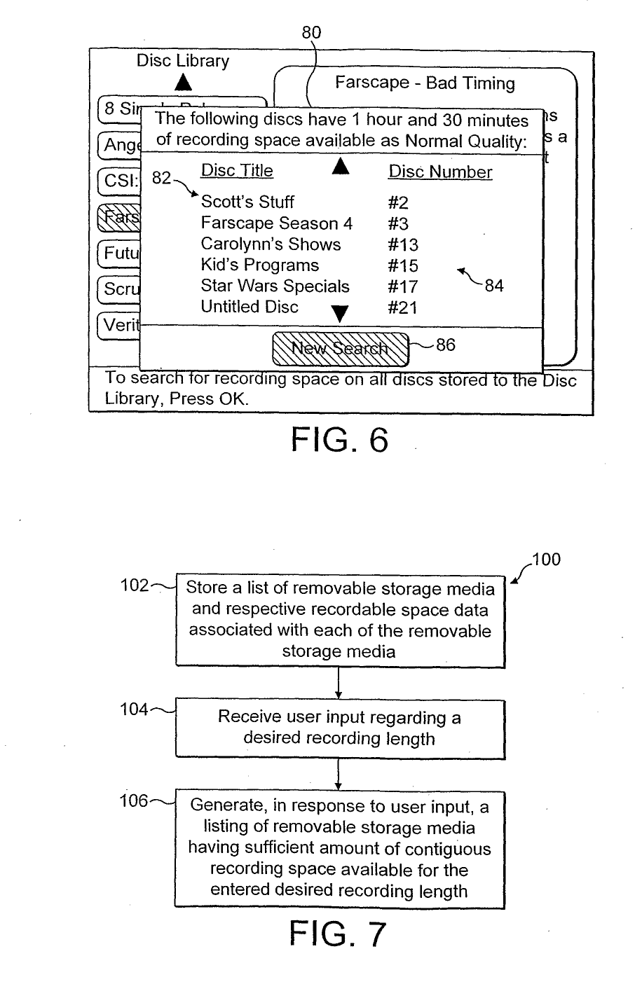

An exemplary screen display or box 80, as illustrated in FIG. 6 is then provided. The box 80 provides the results list 82 that includes all discs that have enough empty, contiguous space available to record at the selected quality level for the length of time entered. A list 84 by disc number is also provided. In this example, the user is also provided with the means to change the search parameters by selecting the “New Search” button 86. As part of the implementation, there might also be an icon or some other indication next to a disc title or disc number to indicate which disc, if any, is currently or already inserted in the device 20.

Referring now to FIG. 7, there is depicted a flowchart, generally designated 100, of an exemplary manner of simple operation of the present invention. In step or box 102, the device stores a list of removable storage media and respective recordable space data associated with each of the removable storage media, along with other data associated with the storage medium. This storage may be initially performed when a user initially records onto a blank disc. In that case, the system assigns an identifier, such as a disc number, which is displayed to the user, and can be used for labeling the disc for future reference. The identifier is also recorded onto the disc itself, in a manner known to those skilled in the art, so that the system can identify the disc whenever the disc is inserted into the recorder/writer and any further recording changes can be stored in the memory of the system. In step or box 104, the device receives user input regarding a desired recording length. In step of box 106, the device generates, in response to user input, a listing of removable storage media having sufficient amount of contiguous recording space available for the entered desired recording length. In the steps above, the appropriate interface/menus may be generated and display using methods known to those skilled in the art.

While this invention has been described as having a preferred design, the present invention can be further modified within the spirit and scope of this disclosure. This application is therefore intended to cover any variations, uses, of adaptations of the invention using its general principles. For example, this invention is particularly suitable for combination units, such as a PVR/DVD-R unit, wherein a user wants to search for suitable discs when transferring programs recorded on the hard drive to a DVD. In that regard, an interface similar to that of FIG. 4 would be provided, listing the attributes of the program and providing a selection button that enables searching of the disc library and listing suitable discs for recording that particular program. Further, this application is intended to cover such departures from the present disclosure as come within known or customary practice in the art to which this invention pertains and that fall within the limits of the appended claims.

1. An apparatus comprising:
memory for storing a listing of removable storage media and respective recordable space data associated with each of the removable storage media;
a controller, coupled to the memory, for causing the respective recordable space data to be stored in, and read out from the memory;
data entry means for receiving user input including search commands related to the removable storage media; and
an on screen display generator, coupled to the controller, for generating a listing of removable storage media having a sufficient amount of contiguous recording space available for a desired recording length entered by a user.

2. The apparatus of claim 1, wherein the listing of removable storage media includes removable storage media within a user specified range.

3. The apparatus of claim 1, wherein the on screen display generator generates a listing of removable storage media having a sufficient amount of contiguous recording space available for a desired recording length and recording quality entered by a user.

4. The apparatus of claim 1, wherein the on screen display generator generates a sorted listing of removable storage media having a sufficient amount of contiguous recording space available for a desired recording length.

5. The apparatus of claim 1, wherein the removable storage media comprises removable optical storage media.

6. The apparatus of claim 1, further comprising recording means for recording programs to a hard drive disc and a recorder/writer means for recording programs to an optical disc.

7. The apparatus of claim 6, wherein the on screen display generator provides a listing of programs recorded on the hard drive disc and upon selection of a program from the listing of programs, provides an option to select a listing of suitable discs for recording the selected program.

8. An audio/video recording device comprising:
means for storing a listing of removable storage media and respective recordable space data associated with each of the removable storage media;
means, coupled to the memory, for causing the respective recordable space data to be stored in, and read out from the storing means;
means for receiving user input including search commands related to the removable storage media; and
means, coupled to the causing means, for generating a listing of removable storage media having a sufficient amount of contiguous recording space available for a desired recording length entered by a user.

9. The recording device of claim 8, further comprising recording means for recording programs to a hard drive disc and a recorder/writer means for recording programs to an optical disc.

10. The apparatus of claim 9, wherein the on screen display generator provides a listing of programs recorded on the hard drive disc and upon selection of a program from the listing of programs, provides an option to select a listing of suitable discs for recording the selected program.

11. A method of operating an audio/video device, the method comprising the steps of:
storing a listing of removable storage media and respective recordable space data associated with each of the removable storage media;
receiving user input regarding a desired recording length; and
generating, in response to the user input, a listing of removable storage media having a sufficient amount of contiguous recording space available for the desired recording length.

12. The method of claim 11, wherein the generating step comprises generating a list of removable storage media within a user defined range of storage media.

13. The method of claim 11, further including the step of receiving user input regarding a desired quality level of recording, and
the step of generating includes generating a listing of removable storage media having a sufficient amount of contiguous recording space available for the entered desired recording length utilizing the entered desired quality level of recording.

14. The method of claim 11, further comprising the step of sorting the listing of removable storage media having a sufficient amount of contiguous recording space available for the entered desired recording length.

15. The method of claim 14, wherein the listing of removable storage media having a sufficient amount of contiguous recording space available for the entered desired recording length is sorted according to amount of available sufficient amount of contiguous recording space.

16. The method of claim 11, further comprising the step of recording a selected program having the desired recording length from a hard drive disc onto an optical disc included in the listing of removable storage media in response to a second user input.

17. A method of operating an audio/video device, the method comprising the steps of:
storing a listing of removable storage media and respective recordable space data associated with each of the removable storage media;
receiving user input selecting a program for recording; and
generating, in response to the user input, a listing of removable storage media having a sufficient amount of contiguous recording space available for recording the selected program.

18. The method of claim 17, wherein the generating step comprises generating a list of removable storage media within a user defined range of storage media.

19. The method of claim 17, further including the step of receiving user input regarding a desired quality level of recording, and
the step of generating includes generating a listing of removable storage media having a sufficient amount of contiguous recording space available for the entered desired recording length utilizing the entered desired quality level of recording.

20. The method of claim 17, further comprising the step of sorting the listing of removable storage media having a sufficient amount of contiguous recording space available for the entered desired recording length.

21. The method of claim 17, wherein the program for recording is selectable from a listing of programs recorded on a hard drive disc and the listing of removable storage media comprises optical discs.
